(19) United States
(12) Patent Application Publication
(10) Pub. No.: US 2015/0142548 A1
(43) Pub. Date: May 21, 2015

(54) METHOD FOR IMPROVING THE UTILIZATION OF MANUFACTURING MACHINES IN MANUFACTURING PROCESSES

(71) Applicant: Thorlabs, Inc., Newton, NJ (US)

(72) Inventors: Alex Cable, Newton, NJ (US); Paul Melone, Budd Lake, NJ (US)

(21) Appl. No.: 14/491,659

(22) Filed: Sep. 19, 2014

Related U.S. Application Data
(60) Provisional application No. 61/880,042, filed on Sep. 19, 2013.

(51) Int. Cl. G06Q 30/02; G06Q 30/06; G05B 19/418

(52) U.S. Cl. CPC G06Q 30/0224; G05B 19/41865; G06Q 30/0635; G05B 2219/31023
USPC 705/14.25

(57) ABSTRACT

Methods, systems, and apparatus, including computer programs encoded on a computer storage medium, for improving the utilization of manufacturing machines in manufacturing processes. In a typical implementation, manufacturing machine utilization is improved by publishing a schedule of Production Events, accepting customer orders within Production Events, and calculating prices for the customers modified based on the customer orders.

### CROSS REFERENCE TO RELATED APPLICATIONS

This application claims the benefit of U.S. Provisional Application No. 61/880,042, filed Sep. 19, 2013, the contents of which are incorporated by reference herein.

### FIELD OF THE INVENTION

This disclosure relates generally to manufacturing processes, and more particularly to a method for improving the utilization of manufacturing machines.

### BACKGROUND

Commercial production processes in many areas, such as machining tool produced metal parts, glass lens production, and lens coating processes, among other processes, can often be most efficiently performed when economies of scale are leveraged. There is often a sliding scale of pricing for products generated through such commercial production processes wherein the price can drop dramatically as the number of orders for the product of the process or the batch size of an order increases. This is optimized as demand approaches the capacity of the process such that the economies of scale are optimal where the demand exactly equals the capacity for a given process.

Frequently, a specialized production process generates substantial inefficiencies where economies of scale cannot be leveraged due to the difficulties associated with finding customers for large quantities of the product of the process, preventing demand from approaching capacity.

It is possible to divide manufacturing processes generally into two categories. The first, Sequential Production, delivers only one, or a few, parts processed per cycle of the process. The second, Simultaneous Parallel Production, delivers a number of parts per cycle, from a few to many thousands.

Where Simultaneous Parallel Production processes are utilized, a number of units are produced for each cycle of a process. In such processes, the entire batch is processed as a lot, with all units within the process being processed simultaneously. In such a scenario, adding or removing parts to the process has little or no effect on the total run time and total cost of the process, but can have significant impact on the unit cost of the parts being produced due to those minimal marginal costs.

Where Sequential Production processes are utilized, just one part is produced at a time. Sequential Production can further be broken into two categories: (1) Conventional Sequential Production and (2) Batched Sequential Production.

In Conventional Sequential Production the process is only capable of processing one part at a time such that one complete production cycle produces only one part.

Batch Sequential Production is defined as a batch of parts, potentially a few to many thousands or millions, being processed whereby the machine or process acts on one or just a few of the parts at any given time and processes parts sequentially. In Batch Sequential Production the process can accommodate many parts such that a machine or process can run for many hours without the attention of an operator. However the process acts on only one part at a time.

Accordingly, economies of scale typically provide two types of efficiencies related to machine utilization. The first is related to machine time, wherein time during which manufacturing machinery remains unused is time during which the machinery could otherwise be utilized and generating profit for a manufacturer if demand for output produced during that time could be found. This type of efficiency could be applied in either Simultaneous Parallel Production processes or Sequential Production processes.

The second is related to machine capacity, wherein unused machine capacity increases the per item cost of products produced using such a process. This is because the cost of running a process usually comprises a substantial fixed cost of running the machinery and a marginal cost representing the per item cost of production at the margin—that is, the cost of producing one more item of the relevant product. This type of efficiency is typically more readily realized, and more dramatic, in Simultaneous Parallel Production processes, but may also exist in Sequential Production processes.

When considering Batch Sequential Production processes, unused machine capacity also typically results in higher operating costs, as a skilled laborer needs to be more attentive to keeping machinery loaded and running. This greater attention is needed so as to maintain the up-time of the machinery, and other manufacturing assets. If the machine isn't loaded to its full capacity the total cycle time of the Product Event is reduced. Further if the unused machine capacity is large and the batch size is small, the setup costs of the Batch Sequential Production process can have a much larger effect on the per item cost of the products produced using such a process.

In many Simultaneous Parallel Production processes, such as lens coating processes, the marginal cost is significantly lower than the fixed cost of running the machinery, and it is therefore desirable to increase the utilization of machine capacity.

In many Batch Sequential Production processes, such as a high capacity Vertical Machining Center (VMC) producing machined metal parts, the labor content (including setup craftsman and machine operators) of the parts being produced can be a significant percentage of the overall costs of the parts. By using palletized machine tools, in conjunction with dense work holding, as well as other strategies for efficiently increasing capacity of systems the capacity of these machines can be expanded significantly. However, these efficiencies can only be fully utilized with significantly raised production volumes justifying the significant time and other investments required to design, build, and setup the dense work holding.

Accordingly, in order to leverage these readily available efficiencies, manufacturers often produce more than is what required or ordered in the near term so as to realize cost savings that they hope will eventually offset the negative effects of tying up capacity and capital (including machine time and storage space). Ideally a manufacturing process would offer both low costs and flexibility in terms of only producing the actual quantity required in the near term while utilizing machine capacity.

Frequently, a specialized production process generates substantial inefficiencies where economies of scale cannot be leveraged due to a mismatch between the capacity of the machine or process and immediate customer demand.

As the economical lot size for a process can often be much larger than the number of parts immediately required by any one customer (or producer), there is a motivation to bundle compatible work from various customers. However, there is a need for internet based tools that are adapted to allow a group of industrial customers and producers (including producing customers) to come together efficiently so as to aggregate their common demand for a unit or service. The need extends to a need for peer to peer networking tools so that customers can coordinate with each other according to a rule based system to fully utilize available capacity and share the added value from such utilization.

### SUMMARY

This specification describes technologies relating to a method for improving the utilization of manufacturing machines through the formation of Buyer Groups. Buyer groups are collections of customers and producers (including producing customers and primary producers who are not customers) who come together to collectively enable a Production Event to be run as efficiently as possible. In general, one innovative aspect of the subject matter described in this specification can be embodied in methods that include the actions of publishing a real-time schedule of Production Events that includes accepting, organizing, and posting customer orders within Production Events, and calculating prices for the customers modified based on the customer orders.

Accordingly, the creation of a rule based network accessed marketplace is described in which business transactions between customers, including those between customers and producing customers, are facilitated so as to minimize the cost of a Production Event for all parties. The cost can be either in terms of the price per unit, or lead time. Both Sequential Production (specifically batch processes), and Simultaneous Parallel Production methods benefit from the system.

Further the system and method may allow potential new customers to register with a host using an alias so as to ensure a degree of privacy for the customer, while still allowing the customer to communicate with other customers and producers. The customer may elect to have the system generate a new alias for each transaction to increase privacy, or to instead have one general alias, allowing the customer to build up a buying history under the general alias that the system can utilize for the purposes of recommendations or other features, or that others can access under certain conditions.

Accordingly, in some embodiments, a customer may be able to reveal all or part of its buying history to a host or to other customers. The system and method may also provide for the buying history and behavior of a customer being accessible to other customers under certain circumstances.

In some embodiments, the system and method would calculate prices—using predetermined rules—for the customers based on all the customer orders or subscriptions that have been recorded for some portion of a specified Production Event. Subscriptions may be implemented to facilitate scheduling recurring production runs, or customers may place orders for a single production run. In some embodiments, the major terms of a production process, such as price, quantity, delivery date, as well as capacity utilization, cost, and yield, among other factors (referenced herein as Production Factors) may be determined by a set of rules implemented in the system and methods. In some embodiments, in place of the rules determining any and all of the unspecified Production Factors, an auction may be used to determine certain Production Factors.

In some embodiments, the system and method would allow for a producer to host a network of customers such that all the customers are provided incentives to aggregate and organize their individual production needs into one Buyer Group.

In some embodiments, the system and method would allow for multiple hosts to coordinate with other compatible hosts where different Production Processes may be required. In such an embodiment, an entire value stream of Production Events could be organized so as to more fully meet the needs of the Buyer Group.

In a preferred embodiment, the computer based method is directed by a host to publish a schedule of Production Events, such as batches of machine manufacturing, lens production, or lens coating processes, and accept customer orders for order slots, such as slots for small volume orders, within batches. Once the method accepts at least one customer order (e.g., an order for a fraction of a batch of lenses coated with anti-reflective coatings) the method presents some of the Production Factors for the remaining capacity in the batch. Typically, the first order may be from a customer that owns the means of production—a producing customer, which is likely to have recurring fractional demand.

Based on the initial order, some fraction of the available capacity is utilized, and some Production Factors are set for the remaining capacity in the batch. In some embodiments, new customers may be able to determine some of the Production Factors, or may be in a position to modify some Production Factors selected by the first customer. In some embodiments, the host facilitates a dialog between the first customer, who may be the producer in this case, and new customers.

The Host may maintain a public bulletin board where future Production Events can be posted by producing customers, and where other customers can post needs for Production Events.

In some embodiments, where a non-producing customer initiates a Production Event, or a request for a Production Event, the new customer order is submitted with some of the Production Factors set by the non-producing customer, e.g. the desired delivery date, and the number of slots required. The host of the system may then determine some of the remaining Production Factors, generating them automatically by the computer software using rules that govern the system; e.g. the price.

The host may then relay the relevant information to a producing customer, who may be able to manage the production process, to make them aware of the potential customer demand, including the potential for recurring demand and/or a subscription, and facilitates the direct dialog between the new, or initiating, customer and the producing customer.

The initiating customer is then free to dialog with the producing customer using a peer to peer platform and potentially adjust one or more of the variables that are part of the larger set of Production Factors. Price, order size, order quality, and delivery date all being potential variables that the producing customer and the initiating customer could manipulate within the system so as to find the optimal tradeoff of the various Production Factors given the needs of the two parties. Later arriving customers may also dialog with existing customers to modify Production Factors as needed.

As long as additional space exists within the Production Event, in this case a batch order, and there is time before the Production Event is scheduled to occur, the method continues to accept new customer orders, and after each customer order, the method modifies one or more commercial factor, including Production Factors, based on updated aspects of the customer orders and the Production Event. Price is the most commonly modified commercial factor typically, as increased utilization of the capacity can typically reduce price for all customers for the Production Event at hand.

In variations of the preferred embodiment, described in detail below, the computer based method is configured to accept orders before batches are scheduled, allow flexibility in the contents of the customer order (e.g., allowing for a compatible process, rather than only the process of the Production Event), or allow customers to transact in a marketplace for orders placed (allowing customers to, for example, sell their order within an earlier batch for a slot in a later Production Event).

Customer involvement in the platform allows the prices for all parties to be reduced automatically as new customer subscriptions are added, and the platform can provide all users with transparency as to the cost. Capacity isn't elastic, and a fully utilized batch Production Event is more efficient for all parties involved.

### BRIEF DESCRIPTION OF THE DRAWINGS

FIG. 1 is a flowchart showing an exemplary implementation of a computer-based method for scheduling production processes.

FIG. 2 is a flowchart showing a second exemplary implementation of a computer-based method for scheduling production processes incorporating several additional features.

FIG. 3 is a flowchart showing an exemplary implementation of a computer-based method for facilitating the scheduling of production processes.

FIG. 4 is a flowchart showing an exemplary implementation of a computer-based method for facilitating the transfer of a manufacturing slot between customers.

FIG. 5 is a flowchart showing an exemplary implementation of a computer-based method for facilitating the ordering of an alternative product in a production process.

FIG. 6 is a schematic representation of an exemplary system that can include an implementation of the invention.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description, the features and benefits of the invention are illustrated by reference to the exemplified embodiments and implementations. Accordingly, the invention expressly should not be limited to such exemplary implementations illustrating some possible non-limiting combination of features that may exist alone or in other combinations; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and implementation of the invention.

For the purposes of this disclosure the method described contemplates at least two types of users. Hosts host the system and process the actual production processes scheduled, and specific hosts may be referenced herein as H1, H2, etc., and customers place orders and reserve space within production processes, and specific customers may be referenced herein as C1, C2, etc. Customers may be producing customers, who actually own production capacity, or may have no capacity and are seeking machine time or space within a production process. In some embodiments, there may be producers who are not customers, but merely provide capacity for third party customers. Similarly, customers, including producing customers, or third party producers may act as hosts. Users of the system are therefore generally referred to as hosts or customers for clarity, but it is understood that all hosts and customers are users of the system.

In a preferred embodiment, the computer based method is directed by a host to publish a schedule of Production Events, such as batches of lens production or lens coating processes, and accept customer orders for order slots, such as slots for small volume orders, within batches. Once the method accepts at least one customer order (e.g., an order for a fraction of a batch of lenses coated with anti-reflective coatings) the method modifies or generates a price based on aspects of the customer's order (e.g., order size, order quality) and/or aspects of the Production Event within which the order is placed (e.g., batch size, percentage of batch filled). While optical lens production batches are described as one example, and machine tool production processes are described as another example, it will be appreciated that embodiments of the system and method described herein could be applied to any type of manufacturing process other than those described herein. As shown in the examples, the method can benefit Simultaneous Parallel Production processes, such as lens coating, as well as Sequential Production processes, such as machining.

As long as additional space exists within the Production Event, in this case a batch order, and there is time before the Production Event is scheduled to occur, the method continues accepting customer orders, and after each customer order, the method modifies prices, or some other Production Factor, based on updated aspects of the customer orders and the Production Event.

In variations of the preferred embodiment, described in detail below, the computer based method is configured to accept orders before batches are scheduled, allow flexibility in the contents of the customer order (e.g., allowing for a compatible process, rather than only the process of the Production Event), or allow customers to transact in a marketplace for orders placed (allowing customers to, for example, sell their order within an earlier batch for a slot in a later Production Event).

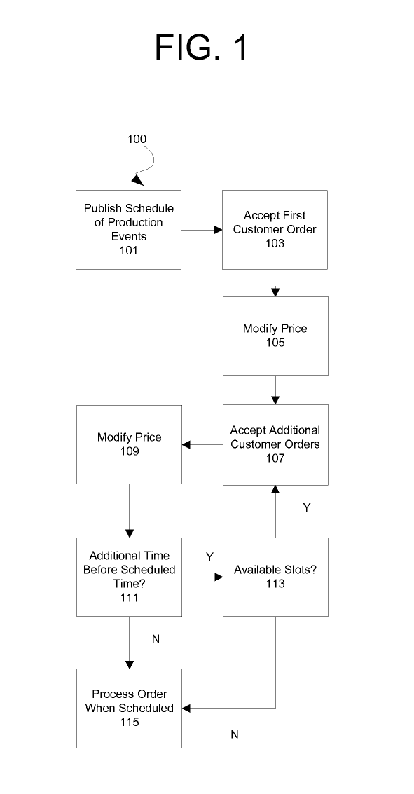

FIG. 1 is a flowchart showing an exemplary implementation of a computer-based method for scheduling production processes 100. As shown in FIG. 1, a host publishes a schedule of Production Events (at 101) containing slots that can be reserved or ordered by customers. A Production Event, as contemplated by this disclosure, refers to either a batch or a run of a production process, where batches and runs are the actual events contemplated by the scheduling system. Batches and runs are processes that assume identical or similar production within a single event. The scheduled Production Events can be, for example, lens coating batches or machine tool manufacturing runs. Alternatively, the scheduled Production Events can be any production process in which it is desirable to create subdivisions in a batch or run. For example, the production process can be any production process for which there is traditionally a large batch production size but a small batch demand.

The schedule of Production Events published (at 101) can be a complete, recurring schedule of Production Events, or it can be a partial schedule. In one example, the production schedule can consist of a single scheduled Production Event, such as a single run or a single batch. In an alternative example, the production schedule can be a complete schedule for a machine or production facility for some amount of time. The production schedule can be cyclical, providing for a fully recurring schedule of Production Events at fixed intervals. For example, the production schedule may be driven by a company's recurring fractional demand, such that excess demand for a regularly recurring process may be fully utilized. The host may be a producing customer, such that a producing customer maintains a schedule indicating available production slots for third party customers.

The schedule may be posted, or modified, by customers having production means (producing customers) such that a producing customer may post a scheduled production run, along with relevant details, in order to facilitate the utilization of portions of the production run that would otherwise remain unused.

Each Production Event scheduled (at 101) may comprise a fixed number of slots for a specified production process, each of which may be a fixed size. Slots are groupings within batches and runs that can be reserved or ordered by individual customers. A slot can represent an order size of an order either placed or contemplated by a customer. For example, a lens production run may be scheduled with ten slots, each containing one tenth of the batch capacity. In alternative embodiments, the production slot may contain a variable number of slots of varying sizes, selectable or customizable by customers. Slots may be larger or smaller than a complete production run or batch.

After publishing the schedule of Production Events (at 101), the method 100 accepts a customer order within a scheduled Production Event (at 103). As an example, one Production Event scheduled (at 101) may be a run of a specified lens coating process containing ten available customer slots, and a customer may place an order (at 103) within that Production Event to fill a single slot. In this manner, the method 100 allows customers to select available slots that suit their needs. In the event that the producing customer is hosting the system and manages the schedule of Production Events, the first order may be already placed at the time of the posting of the Production Event, and a limited number of slots may be made available to other customers.

When a customer places an order (at 103) a computer system implementing the method modifies a price (at 105) based on aspects of the customer order. It will be understood that throughout this disclosure, wherever the description speaks of modifying a price, the method may modify a different commercial factor or Production Factor instead of modifying price. Occasionally, the price is initially defined after the first customer order is placed, and is modified only after additional orders are placed. The modification can be based on, for example, the type of run, the quality of the run, the specified product or other characteristics of the run or product, the timing of the run, or the quantity ordered by the customer. The quantity can be the size of the slot ordered (e.g., the number of lenses in the ordered production slot) and/or the number of slots ordered. In some embodiments, a price is generated for the first customer based on the characteristics of the order, and the generated price is modified for future customers.

The exemplary embodiment provides the modified price (at 105) after the acceptance of the customer order. In some embodiments, the modified price is generated before the customer places the order, and the customer has an opportunity to accept or reject the proposed price. Similarly, the price may be based on a known algorithm, with a formula published to potential customers.

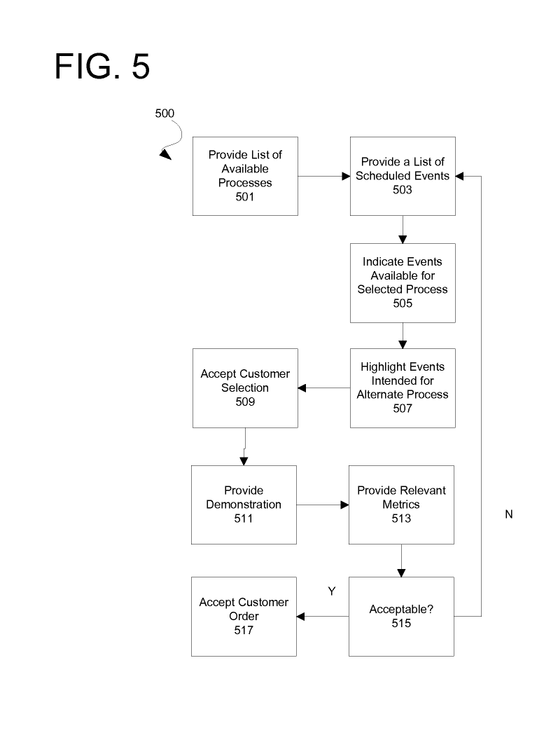

After a first customer order has been placed (at 103) the computer system implementing the method continues to accept additional customer orders (at 107) for the same Production Event as the order of the first customer. In the exemplary embodiment, the additional customer orders accepted are for identical products, in this case a specified lens coating process, to be processed within the Production Event. In alternative embodiments, additional customer orders may be for different products, such as compatible products. Compatible products, as contemplated by this disclosure, are products that can be produced within a Production Event intended for a different primary product. Such an order may be placed using, for example, the process of FIG. 5, below.

When an additional customer order is accepted, the computer system implementing the method modifies the price (at 109) provided to the additional customer. The price that gets modified and recalculated may be referenced as a system price. The price may be based on similar factors to those considered in reference to the first customer (at 105). In some implementations, the price is identical for all customers on a per unit basis (e.g., a price per lens coating is based on the number of lens coatings ordered by all customers combined). In alternative embodiments, the price is weighted based on factors related to individual customers (e.g., a price per lens coating is based on both the total quantity ordered and the quantity ordered by the particular customer).

In the exemplary embodiment, the computer system implementing the method continues to accept orders as long as there is additional time before the scheduled production time (at 111) and there are available slots for additional orders (at 113). In some embodiments, the scheduled time may be adjusted based on, for example, availability of production facilities, options selected by users, additional availability of slots, or any other factor. In other embodiments, the scheduled time is fixed. The Production Event is then processed when scheduled (at 115).

The host may be a producing customer, or it may be a third party acting solely to facilitate the interactions between customers. Similarly, the method and system may be applied to hosts in order to more efficiently coordinate hosts managing different portions of production processes, thus allowing for a more complete coordination of production processes and the generation of a value stream.

Further, where specifics of a scheduled Production Event may be infeasible for a specific customer, the customer may wish to communicate with the host or with a producing customer. In such an embodiment, the use of the internet, or some other computerized network, including specialized peer to peer networks, allows customers to interact with other customers (including producing customers), and request an optimization of a process. Such a minor optimization, such as an adjustment of a delivery date, may allow more customers to leverage a single Production Event, thereby further increasing the utilization efficiencies.

For example the first order into the system may have a delivery date that isn't compatible with the interests of a later customer. The later customer could then communicate the need for an earlier delivery in exchange for a medication of a preferred Production Factor, such as an increased price, for example. As the producing customer is typically first in and controls the production process to some degree, the producing customer is typically given veto rights over additional new customers who seek to change the Production Factors. Generally some portion of the consideration given by the new customer for changing the existing Production Factors, would go to all earlier customers, who are having their order modified. The host could choose to use a fully automated system for providing the adjustments in Production Factors, or the host could elect to allow the parties to negotiate directly, or the host could choose to intervene directly to set the terms.

As benefits of the aggregation of work are realized through the implementation of the system and through the enabling of customer to customer interactions governed by a set of rules, the benefits typically filter down to customers in the form of reduced costs. Those benefits are typically shared across a Buyer Group, but may not be shared equally. In some embodiments, hosts, or producing customers, may receive disproportional benefits, or hosts may control the distribution of such cost savings, and other benefits.

In some embodiments, hosts may implement progressive pricing models. Such a model is designed such that when sharing the cost savings on jobs that run repeatedly over long periods, distributions of savings are backend loaded, encouraging long term cooperation.

As some of the Production Events will act upon user supplied, or externally supplied materials, some implementations may provide for an efficient means to organize the production, and delivery of the required materials. A Secondary Producer may be involved in providing or facilitating the provision of those required materials. In some embodiments, secondary producers may support primary producers by delivering batch results to the primary producer instead of directly to customers.

Customers participating in the method of FIG. 1 may have profiles maintained within the platform. These profiles may maintain information about the customers and make that information available to other customers or hosts, or it may maintain the information in confidence. In some embodiments, customers may participate using an alias to place orders. In some embodiments, the platform may generate new aliases for a user each time an order is placed. Alternatively, all orders may be applied to a single alias, such that privacy may be maintained, but the customers buying history may be utilized by the platform for various purposes, such as the suggestion of processes in which the user may wish to participate.

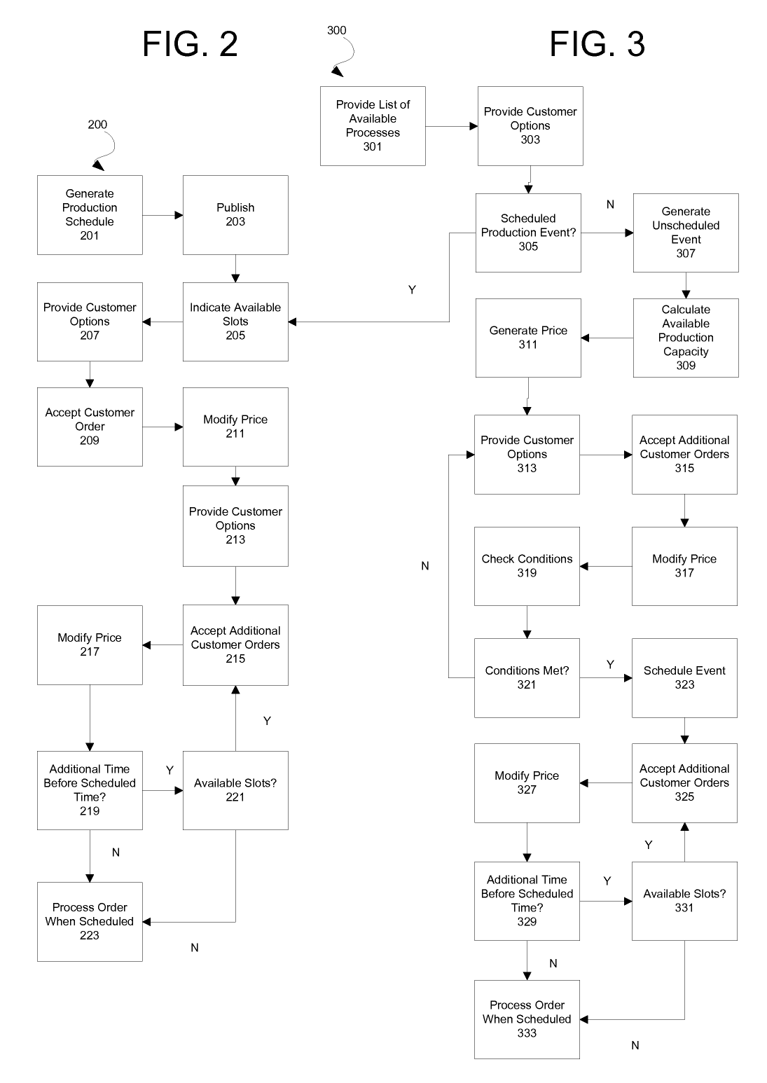

FIG. 2 is a flowchart showing a second exemplary implementation of a computer-based method for scheduling production processes incorporating several additional features.

As shown in FIG. 2, a host can generate a production schedule (at 201). As in the method 100, the production schedule can be a complete, recurring schedule of Production Events, or it can be a partial schedule.

The production schedule (at 201) may be completely void of previously ordered slots or it may have substantial portions of the production schedule previously ordered for regular production. Typically, where the host is a producing customer, the schedule may be based around partially utilized regular orders. Certain portions of the production schedule may therefore by unavailable to customers through the method 200. In some embodiments, the production schedule is a previously existing production schedule for a facility, and the method 200 may be implemented to make available previously wasted production capacity. Where, for example a production facility regularly produces a portion of a batches capacity of a specified lens coating process on a quarterly basis, the host may choose to make the remainder of the batch capacity available to customers for custom batches at reduced prices.

After a production schedule is generated 201, the method 200 publishes 203 the production schedule and indicates any production slots that are available to customers 205. As above, slots may be of fixed sizes, or they may be generated to match the size of incoming orders. Slots may automatically be generated that are some fraction of the available portion of the Production Event (e.g., where a production facility has an annual half-filled batch of a specific process, the remainder may be divided into ten slots).

When a customer seeks to order a production slot, the system can, optionally, provide the customer with several options 207. These options can include, for example, a customer selected maximum price for production, or an indication of the customer's interest in being alerted to a potential sale or exchange of the customer's order. Alternatively, a customer may be able to indicate a preference towards cost savings or towards a scheduled Production Event as selected, or towards a slot in an earlier Production Event, if one becomes available. Similarly, a customer may indicate a high willingness to sacrifice his ordered slot for a reduced price. In some embodiments, the customer may be able to indicate a preference towards having the system select an appropriate slot in an appropriate Production Event, or directly selecting an appropriate slot in an appropriate Production Event.

In some embodiments, the first customer may be able to expand or limit the options available to customers arriving later. In some embodiments, any options presented to the user may be, instead, contained in a user profile and applied to all user activities within the method and other methods contained within a larger system.

The method may require a deposit before accepting any customer orders. This deposit may become due before or after the customer learns the potential price of his order. In some embodiments, the deposit may be waived for certain customers if, for example, they are regular customers or they keep funds in a deposit account.

After a customer indicates any preferences allowed for by the method, the method accepts a customer order 209. The order placed by the customer can be for a complete run or batch of a specified process or it can be the selection of a slot available within a scheduled Production Event within the production schedule. In some embodiments, the customer may request a custom production slot, wherein the customer indicates the size of an order, and the method then incorporates that order into the existing production schedule, if possible. If the specified custom production slot is unavailable (e.g., the customer requests an uncommon lens coating procedure or an unavailable slot size), the customer may be rejected by the system, or may be redirected to a method within the system designed to handle specialty orders, such as the computer-based method 300 of FIG. 3. In the alternative, the system may direct the user to a method designed to incorporate compatible orders into the existing production schedule, such as the method 500 of FIG. 5.

In the exemplary embodiment of the computer-based method 200, after the method accepts a customer order (at 209), the method modifies a price (at 211). The price can be modified or generated as in the method 100 (at 105), and it can be based on the total number of units scheduled for the Production Event by all customers, including those incorporated into the initial production schedule. Further, the price can, for example, be affected by many additional factors, including the set of options selected by the customer. The method 200 may indicate that no per unit price is possible due to customer selected constraints, such as a maximum price. The method may then cancel the order, or it may hold the order in the event that the conditions may be met before a relevant time (e.g., the price is lowered by future orders). In some embodiments, the method may not generate or modify a price until some condition is met. For example, the method may defer price generation until a minimum order size is met. The price modified by the method (at 211) may be applied only to the customer ordering a slot, or it may be applied to all orders within the Production Event specified (e.g., a reduced price may be applied to regular production processes previously incorporated into the schedule). Similarly, prices for earlier orders may be modified based on a calculation different than that applied to the customer.

In alternative embodiments, the method 200 may provide pricing incentives for customers ordering slots in Production Events early. The method may, for example, provide discounts for orders placed in advance of a scheduled Production Event by a certain amount of time, or for the first order placed in any Production Event. Alternatively, the system may indicate potential efficiencies that the customer may be able to leverage, such as the incorporation of the order into a different production run or a different batch of the same type of Production Event, or the incorporation of the order into a different production run or batch for compatible Production Event. This option is discussed below in reference to FIG. 5.

After the exemplary method 200 modifies a price for a first customer (at 211), it allows for additional customers to select from similar customer options (at 213) and accepts additional customer orders (at 215) in a similar manner to accepting the first customer order (at 209). After each accepted additional customer order, the method generates an updated per unit price (at 217). The generation of an updated per unit price can be similar to the price generation described above in reference to the generation of the first per unit price (at 211). The updated per unit price can be applied to all users in the relevant Production Event, or it can be applied only to the additional customer order accepted (at 215). Alternatively, it can be applied to any subset of orders in the system. The options available to customers may be limited in some situations. For example, in some embodiments, the customer ordering the first slot in a Production Event may be able to limit or expand the options available to later customers.

The computer-based method 200 continues to accept additional customer orders (at 215) and modify the per unit price (at 217) as long as additional time is available (at 219) and additional slots are available (at 221). The Production Event will then occur when scheduled (at 223).

FIG. 3 is a flowchart showing an exemplary implementation of a computer-based method 300 for facilitating the scheduling of production processes.

In the method 300, the host provides a list of available production processes (at 301) that can be selected by customers to generate a Production Event (e.g., a list of lens coatings that can be applied by the production facilities). When a customer selects a process from the list of production processes, in some embodiments, he is provided with customer options (at 303). These options can largely correspond to those provided (at 207) to customers in the method 200 for scheduling production processes. Additionally, the system may provide additional options specific to the method 300 for facilitating the scheduling of production processes. These additional options can include, for example, the option of immediately scheduling a Production Event, indicating a preference towards earlier production times or lower costs, or indicating a latest time at which the Production Event should preferably occur. Alternatively, a customer can create a set of criteria that must be met in order for the event to be scheduled. The criteria can include, for example, some combination of thresholds within the earlier options. Further options can include allowing slots to be ordered for compatible production processes, such as those discussed below in reference to FIG. 5.

In some embodiments, the customer may allow the Production Event to be transformed into an alternative production process, leaving his process as a compatible production process (such as that discussed in reference to FIG. 5).

If a customer chooses to generate a scheduled Production Event (at 305), then the customer may be able to select an available slot in a production schedule, such as that generated in method 200 at (at 201), and will then be directed to an indication of available production slots (at 205). If no scheduled Production Event is available, the method 300 may publish the scheduled Production Event generated (at 203) and the computer system may continue to implement the method 200 in reference to the scheduled Production Event. In order to publish a scheduled Production Event, the method 300 may require that certain criteria are met, such as some minimum size order or some minimum total price.

If a customer chooses to generate an unscheduled Production Event (at 307), the method will record the event as unscheduled and partially filled (e.g., a lens coating process with available capacity). The method will then calculate available production capacity in the Production Event (at 309) and generate a price (at 311). The first per unit price can depend on many of the same factors incorporated into the unit price modified in method 100 (at 109). Additionally, the price can be based on any options selected specific to an unscheduled Production Event, such as options related to timing preferences of the event (e.g., scheduling or production deadlines).

As in the method 200 above, a customer may be required to place a deposit in order to generate a Production Event or order a slot in an existing Production Event.

The available production capacity is then made available to customers in much the same way that scheduled Production Events are made available in method 200, modified to account for the fact that a Production Event is not yet scheduled. The method does this by providing customer options (at 313) and accepting additional customer orders (at 315) similar to those at 213 and 215. In addition to the customer options described above, the customers may be presented with additional options related to scheduling an unscheduled Production Event. Customers may be able to express preferences towards an earlier or later production time or a lower price. In some embodiments, customers may be provided with a voting interface or some other interface for indicating a preference towards a specified production time or pricing details, such as a maximum price. Further, in some embodiments, the initiator of the unscheduled event may be able to limit or clarify the options available to additional customers.

After any additional customer orders are created, the method can generate an updated per unit price (at 317). The updated price can incorporate any of the factors indicated above and can be specific to the additional customers or the updated price can be applied to all customers. In some embodiments, the method generates updated prices for all orders in the Production Event with all updated prices being based on one or more global characteristic of the Production Event (e.g., percentage of the Production Event that is being used) and one or more factor specific to the order (e.g., the size of the specific order).

In some embodiments, several orders placed within an unscheduled Production Event can be treated as a single order placed by a buying group (e.g., when multiple customers seeking an identical production process agree to order as a single customer). The order can then, in some embodiments, be treated as a single order for the purposes of scheduling the unscheduled Production Event or for reserving an acceptable order slot in a scheduled Production Event. A buying group, if generated, can act as a single customer based on, for example, previously selected options or a group vote. Alternatively, the buying group may act based on any other method of forming a consensus.

In some embodiments, after each order is incorporated into the unscheduled Production Event, the method will check a set of conditions (at 319) in order to determine if the unscheduled Production Event should be scheduled. The conditions can incorporate an assessment of the accounted for or remaining capacity of the Production Event, either in terms of absolute units (e.g., the number of lenses to be processed) or in percentage of the Production Event ordered. The conditions can also incorporate preferences of the initiator of the unscheduled event as well as preferences of customers holding orders (e.g., individual customers or buying groups). In the event that the options selected by the initiator and/or the later customers do not constitute an actionable set of criteria, the method may incorporate a default set of criteria, and/or a set of gap filling criteria which can include, for example, scheduling an event when a certain percentage of the event is ordered or scheduling the event when the price falls below a certain point. In some embodiments, the default criteria may be a set of criteria presented to users as options that can be accepted or altered.

If the conditions are not found to be met (at 321), the Production Event remains unscheduled and the method continues to accept orders. If, however, the conditions are found to be met, the event is scheduled (at 323). The scheduling can be according to an algorithm for finding unused production time in a broader production schedule or it can be based on other criteria, such as a combination of user preferences.

After the event is scheduled, the method 300 can continue in much the same manner as the earlier method 200. The method 300 will continue to accept additional user orders (at 325) and generate updated per unit prices (at 327) as long as there is additional time before the scheduled time (at 329) and additional available slots (at 331).

Finally, the Production Event is processed and completed at the scheduled time (at 333).

As an example, the methods outlined would allow a number of customers to share the capacity of a vertical machining center (VMC), where the ideal would be to tool up the VMC such that 100% of available capacity is utilized (with some reserve capacity remaining for servicing the asset, potentially). Accordingly, three customers, C1, C2, and C3, each with a need for a continuous supply of component parts milled from 6061 aluminum, may utilize the platform. A blank is typically a component part that is fed into a Production Event, such as a finished lens that is fed into a thin film coating Production Event, or a block of metal to be machined. In the example, the blank for C1 is 12 mm by 50 mm by 75 mm, the blank for C2 is 10 mm by 60 mm by 80 mm, and the blank for C3 it is 18 mm by 55 mm by 80 mm. C1 is a producing customer, and owns the means to produce the parts, and subscribes to a specific host H1, where C1 posts the production run in which its parts are being produced in order to increase the potential productivity of its VMC. The platform then prompts C1 to enter the details of the production asset being used, including the hardware, software, and personnel utilized, and the system searches for other customers with compatible needs. In this case, the details provided may be:
a. Material—6061-T6 aluminum.
b. Timing—Weekly shipments of parts.
c. Quantity of parts—200 units.
d. Dedicated soft jaw work holding—Chick QwikStak.
e. Size, and compatible sizes.
f. Tolerance—+/−0.003, except where noted on drawings.
g. Required Surface Finishes—32 micro-inches.
h. Geometrical tolerances as noted.
i. Number of work holding events.
j. Machine details, including total area on machine for fixturing.

Other details may be provided as well. In such an example, the equipment used may be set up such that a single tool may act on the multitude of blanks simultaneously or consecutively within a single production process.

After posting, the platform may identify customer C2, who may have already entered the Production Factors for its job into the host H1. With the same material requirements, and a job that can be handled by the specified machine, the jobs appear to be compatible to H1. H1 then connects C1 and C2 such that they can communicate directly and determine if the jobs are compatible. After the consultations, it may be clear that the jobs can be combined, and that each of C1 and C2 has ongoing needs that may continue for years, leading to an efficient subscription of services.

In such an embodiment, the system may then exhibit the following utilization for the production process:

| | | | | | | | | | | | Weekly |
|---|---|---|---|---|---|---|---|---|---|---|---|
| | | | | Area | | Cycle Time | Annual | Weekly | Min per | Percent of | Demand |
| Customer | Job | Thickness | Width | Height | mm\hat{ }2 | Min | Demand | Demand | Year | Capacity | in Minutes |
| C1 | 1 | 12 | 50 | 75 | 3,750 | 6 | 10,400 | 200 | 62,400 | 50.00% | 1200 |
| C2 | 2 | 10 | 60 | 80 | 4,800 | 7 | 2,080 | 40 | 14,560 | 11.67% | 280 |

From the table, the production process operated by C1 is still only 61.67% utilized, so H1 may then continue to identify additional customers, such as C3. At some utilization level, C1 may choose to commit to the cost of setting up the VMC, thereby locking in the scheduled production.

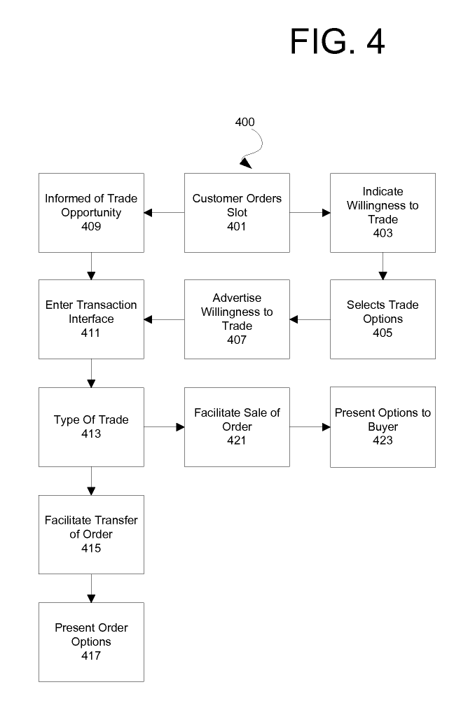

FIG. 4 is a flowchart showing an exemplary implementation of a computer-based method 400 for facilitating the transfer of a manufacturing slot between customers. In the exemplary implementation, the method can be accessed by a customer after the customer places an order for a slot in a Production Event (at 401). The order can be placed using the methods described in reference to FIGS. 1-3, or through some alternative process that results in an ordered or reserved slot. In an alternative embodiment, a customer may be able to indicate willingness to trade (at 403) without first ordering a slot. If this is done, a user may later face limited options and may only be able to buy a production slot through the facilitation of a sale (at 421) rather than being able to trade an order.

In the exemplary embodiment, a customer orders a slot in a Production Event (at 401). Once the order is placed, the customer is presented with trade opportunities (at 409). A customer's willingness to entertain potential trade opportunities may be indicated in the customer's options upon placing an order or it may be indicated in the customer's profile (e.g., a customer may indicate that time is less critical for his needs, and therefore he may be willing to sacrifice his ordered time slots for improved pricing).

Alternatively, a customer may indicate a high willingness to trade (at 403) his own order slot. If a customer indicates that he is willing to trade his order slot, he may be presented with further options (at 405). The further options may contain, for example, an indication of the strength of interest in trading an order slot. The options may further include an indication of acceptable parameters of potential transactions. The parameters may include price, size of order and limitations on the portion of the customer's orders he is willing to trade.

In some embodiments, a customer may advertise his own willingness to trade (at 407). In alternative embodiments, the system may keep a database for presentation to customers cataloging time slots that are available for transactions and, for example, presenting time slots available for transactions alongside other available time slots. In some embodiments, a customer may be able to prioritize his own advertised willingness to trade by, for example, paying a fee. Advertised potential transactions may be presented to other customers, such as the informing of customers upon the ordering of a slot (at 409).

In the exemplary embodiment, once a customer has been informed of a trade opportunity (at 409) and decides to pursue the opportunity, the customer can enter a transaction interface (at 411). Alternatively after a customer advertises willingness to trade (at 407), the trade opportunity may be accepted or pursued by a customer, and the customer will enter the transaction interface (at 411) (e.g., advertised opportunities may be made executable or non-executable). The transaction interface contains, for example, various tools for negotiating acceptable terms of a transaction. The transaction interface may be configured to process both sales of ordered slots and trades of ordered slots. Once terms have been agreed upon by the customers, the transaction interface (at 411) directs customers to the appropriate platforms based on the type of trade they are pursuing (at 413). The method can then facilitate the transfer of orders between multiple customers or facilitate the sale of an ordered production slot (at 421). After the transaction has been completed, order options related to newly acquired slots are presented to customers at (at 417 and 423). The order options may be limited, for example, to options that can be edited after placing a traditional order.

FIG. 5 is a flowchart showing an exemplary implementation of a computer-based method for facilitating the ordering of an alternative product in a production process. The method 500 of FIG. 5 can be incorporated into the scheduling process for a Production Event, such as the process described in FIGS. 1-3. It can also be integrated into any other production process for which processing an alternative product within a fixed production process is a viable option. In the exemplary embodiment, a customer attempts to order a slot in a Production Event using a scheduling system such as that described in FIGS. 1-3. After a production schedule is published (at 203), a customer may seek to order space in any available production slot. If, however, the available production slots do not specify the customer's required process the customer may access the method 500 for facilitating the ordering of a compatible alternative process in a Production Event.

Upon accessing the exemplary method, a customer is, in the exemplary embodiment, provided with a list of compatible processes (at 501). The customer may select an event from the list of compatible processes, or the customer may instead browse a list of scheduled events (at 503). When the customer selects a process from the list of processes (at 501) or an event from the list of events (at 503), the method indicates all events that are compatible (at 505) with the selected process (at 501), or, in alternate embodiments, the method indicates all processes that are compatible with the selected Production Event (at 503). When presented to the customer, the method highlights all events that are intended for compatible processes rather than the indicated process. The customer may then select an event intended for the specified process, or an event intended for a compatible process.

When a customer finds an acceptable production slot compatible with the required process, the customer can select an event in which to order a slot. If the event selected is intended for the required process, the customer is directed to an order system, such as that of FIG. 2, in order to complete his reservation. If however, the customer selects an event intended for a process other than that required, the method accepts the customer's selection (at 509) and provides a demonstration (at 511) of the expected result. The demonstration provided can be a visual image of the expected result of the selected process being run with the selected event. Alternatively, the system may indicate expected differences between the selected process completed in an event intended for the selected process and the selected process completed in the selected event.

In addition to providing a basic demonstration (at 511), the method may also provide metrics (at 513) relevant to the scenario requested. If the requested process is a lens coating, for example, the metrics may indicate expected variations in hardness, scratch resistance, opacity, reflective indexes, appearance, as well as other metrics relevant to the resulting product.

If the customer indicates that the expected results are unacceptable, the customer may be returned to a list of events (at 503). If the customer does not find the results from any options acceptable, he may exit the system, or attempt to generate an unscheduled event, such as that provided in the method of FIG. 3. If the user indicates that the expected results acceptable (at 515), the method accepts the customer order (at 517), and returns the customer to a scheduling system, such as the method 200 of FIG. 2, to complete the order. In the illustrated embodiment, the method 500 of FIG. 5 can be fully integrated within the methods of FIGS. 1-3.

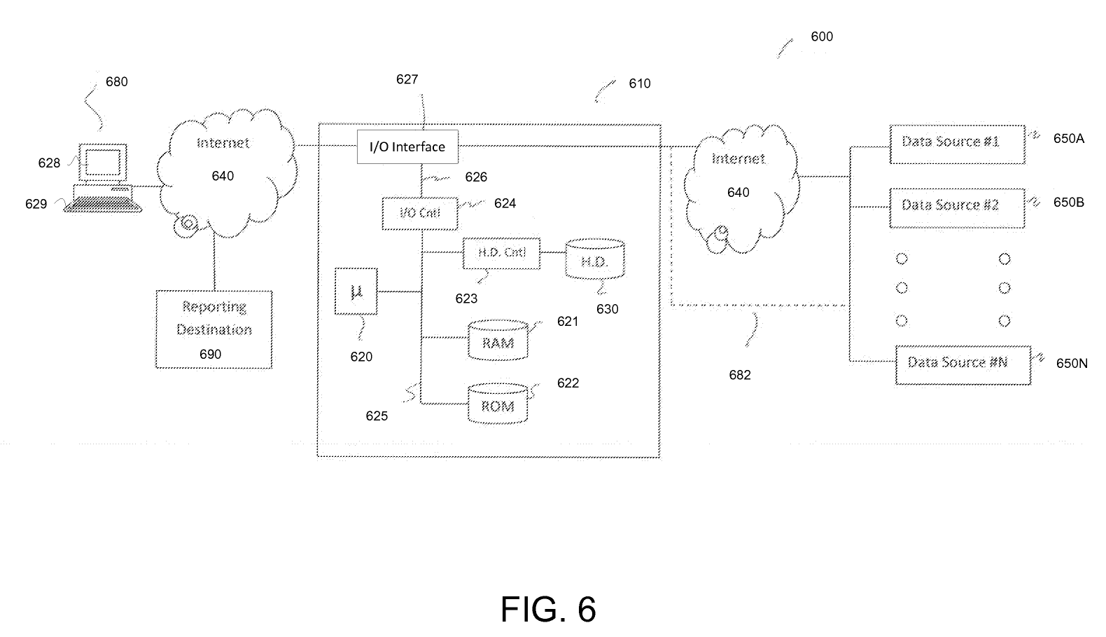

FIG. 6 is a schematic representation of an exemplary system that can include an implementation of the invention.

The operations described in this specification can be implemented as operations performed by a data processing apparatus on data stored on one or more computer readable storage devices or received from other sources. For example, FIG. 6 is a schematic representation of an exemplary system 600 configured to perform one or more operations described in this specification. The illustrated system 600 includes a data processing apparatus, such as a programmable processing system 610. The programmable processing system 610 is coupled via the internet 640 to a user terminal 680, a plurality of data sources 650A, 650B . . . 650N, and, optionally, at least one reporting destination 690. The data sources may be, for example, preset production schedule databases, process detail databases, such as time or materials required for specified processes or preferred sequences of processes, data related to customer preferences, etc. The reporting destination 690 may be, for example, for reporting results and scheduled events to a system host or a separate system for processing scheduled processes. The reporting destination 690 may be, for example, a lens production machine, configured to automatically implement requested orders. In alternative embodiments, the data sources 650A, 650B . . . 650N may be replaced by databases internal to the programmable processing system 610. As indicated by dashed line 682, one or more of the data sources 150A, 150B . . . 150N may also be connected directly to the processing system 610.

In a typical implementation, the programmable processing system (system) 610 includes a processer 620, a random access memory (RAM) 621, a program memory 622 (for example, a writable read-only memory (ROM) such as flash ROM), a hard drive controller 623, and in input/output (I/O) controller 624 coupled by a processor (CPU) bus 625. The system 610 can be programmed by loading a program from another source (for example, from a floppy disk, a CD-ROM, or another computer).

The hard drive controller 623 is coupled to a hard disk 630 suitable for storing executable computer programs, including programs embodying aspects of the subject matter described in this specification, such as programs for illustrating compatible products in the method of FIG. 5, and data discussed in this specification, such as production process details and customer profiles.

The I/O controller 624 is coupled by means of an I/O bus 626 to an I/O interface 627. The I/O interface 627 receives and transmits data in analog or digital form over communication links such as a serial link, local area network, wireless link, and parallel link as well as the internet 640. In some implementations, the I/O interface 627 is connected to a user terminal 680 having a display 628 and a keyboard 629.

In one aspect, the I/O interface 627 is operable as a production schedule interface, for publishing and reviewing production schedules. In another aspect, the I/O interface 627 is operable as a transaction interface for placing production orders within a production schedule, placing production orders external to a production schedule, or trading production orders with other users. In some aspects, the I/O interface relies on data for accepting customer orders or facilitating customer transactions. In a typical implementation, the data can be obtained from one or more data sources (e.g., 650A, 650B . . . 650N). The data sources can include, for example, a computer terminal where data is entered manually.

The I/O interface 627 also provides an access point for users at one or more user terminal 680 or at a reporting destination 690 to interact with and access the data and functionality disclosed herein. Typically, a customer will access through a user terminal 680 and a host will access through a reporting destination 690, but in some embodiments, such as in preparing a production schedule for publication, a host may access through a user terminal as well.

The I/O interface 627 in the illustrated implementation, also serves as an interface to a reporting destination 690, which can also be an access point for a user of the system. Thus, in a typical implementation, any desired reporting, such as reporting results, can be accomplished directly from the user terminal 680 or the reporting destination 690, for example, by accessing the processing system 610.

The I/O interface 627 in the illustrated implementation, also serves as a marketplace interface, through which a user of the system may generate transactions of manufacturing process times slots. The user may also propose or receive proposed transactions through the I/O interface 627. The instructions for such transactions can be sent from the I/O interface 627 over one or more networks, such as the Internet 640 to the one or more user terminals 680.

The processor 620 may be adapted to calculate appropriate pricing for production processes, as well as calculating results for production runs or batches being used to complete alternative production processes. This information, among other information, can be stored in an electronic database, for example, in RAM module 621.

The display 628 and the keyboard 629 can, in a typical implementation, form an exemplary user interface. The display 628 is generally configured to present information to user that would be useful for that user. This can include, for example, alerts indicating the availability of a potential transaction, or of an accessible alternative production process. In some embodiments, the reporting destination 690 is coupled to a secondary user interface that can include a second display and a second keyboard.

Embodiments of the subject matter and the operations described in this specification can be implemented in digital electronic circuitry, or in computer software, firmware, or hardware, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The term “computer system” or “computer-based method” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be indicated in the numbered paragraphs near the end of this disclosure, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described in the numbered paragraphs near the end of this disclosure as such, one or more features from such a combination can in some cases be excised from the combination, and the combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A computer-based method for scheduling production processes comprising:
publishing, over a computerized network, a schedule of production events,
accepting a first customer order within a first production event,
accepting at least one additional customer order within the first production event,
wherein a price is impacted by the first customer order and the at least one additional customer order.

2. (canceled)

3. The computer-based method of claim 1, further comprising calculating the price before accepting the at least one additional customer order, and recalculating the price after accepting the at least one additional customer order.

4. The computer-based method of claim 3, wherein the price calculated is in part dependant on one or more of the sum of the volume of all orders within the production event, the percentage of the production event capacity projected to be used by all orders, the size of a specified customer's order, the type of production event, and the quality of the production event.

5-6. (canceled)

7. The computer-based method of claim 1, wherein the first customer and the at least one additional customer indicate a preference from the group consisting of cost savings and time urgency.

8. The computer-based method of claim 1, wherein the first customer and the one or more secondary customers have the option of indicating a maximum price.

9-10. (canceled)

11. The computer-based method of claim 10, further comprising accepting orders within the first production event for processes other than the specified production process, where one or more customers request slots in the first production event for processes other than the specified production process.

12. The computer-based method of claim 11, further comprising presenting to the one or more customers expected results of the process other than the specified production process.

13. A computer-based method for scheduling a production process comprising:
generating a first production event at the request of a first customer received from a computer-based interface device,
presenting the first production event to one or more secondary customers, and
assigning at least one slot in the first production event to the one or more secondary customers,
wherein a price is impacted by the first customer order and the at least one additional customer order.

14. The computer-based method of claim 13, wherein the first production event is unscheduled.

15. The computer-based method of claim 14, further comprising scheduling the first unscheduled production run when one or more conditions are satisfied, and wherein the one or more conditions are selected out of the group consisting of the total utilized capacity of the production process is greater than a threshold amount, the total utilized capacity of the production process is greater than a threshold percentage of the total capacity of the production process, a total number of customers is greater than a threshold amount, and the first customer and the one or more secondary customers indicates a willingness to proceed.

16. (canceled)

17. The computer-based method of claim 13, wherein the first customer and the one or more secondary customers indicate a preference from the group consisting of cost savings and time urgency.

18. The computer-based method of claim 13, wherein the first customer indicates a maximum price.

19. The computer-based method of claim 18, wherein the production event is scheduled upon generating a price for the first customer lower than the indicated maximum price.

20. The computer-based method of claim 13, wherein the first customer and the one or more secondary customers have the option of indicating a maximum price.

21-22. (canceled)

23. The computer-based method of claim 22, further comprising assigning slots in the first production event for processes other than the specified production process, where one or more of the one or more secondary customers request slots in the first production event for processes other than the specified production process.

24. The computer-based method of claim 22, further comprising providing for selection by one or more secondary customers a process other than the specified production process for the production event, presenting to the one or more secondary customers expected results of the process other than the specified production process, and providing an order in the unscheduled production run for the one or more secondary customers for a slot in the production event for the process other than the specified production process.

25. The computer based method of claim 13, wherein the first customer and the one or more secondary customers advertise the availability of the first unscheduled production run.

26. The computer-based method of claim 13, further comprising calculating the price before presenting the first production event to the one or more secondary customers, and recalculating the price after assigning at least one slot to the one or more secondary customer.

27. The computer-based method of claim 26, wherein the price calculated is in part dependant on one or more of the sum of the volume of all orders within the production event, the percentage of the production event capacity projected to be used, the type of production event, and the quality of the production event.

28. (canceled)

29. A computer-based method for facilitating a transfer of an ordered slot in a production process comprising:
receiving at least one indication from a computer-based interface device that a first customer seeks a counterparty interested in acquiring a slot in a production event,
receiving at least one indication from a computer-based interface device that a second customer is willing to transact on the opposite side of the market from the first customer for the acquisition of an ordered slot in a production event,
providing an interface for the sale of a first ordered slot in a first production event from one customer to another, and
transferring the first ordered slot in the first production event from one customer to another.

30. The computer-based method of claim 29, further comprising providing an interface for the transfer of an ordered slot in a production process from the buyer to the seller, where the buyer has a previously ordered slot.

31-46. (canceled)
